(19) United States
(12) Patent Application Publication
(10) Pub. No.: US 2009/0185608 A1
(43) Pub. Date: Jul. 23, 2009

(54) METHODS AND SYSTEMS FOR SURVEYING, ANALYZING AND PRESENTING POINT TO POINT MIMO CHANNELS USING INFORMATION EXCHANGED BETWEEN IEEE 802.11N COMPLIANT NODES AT THE MEDIA ACCESS CONTROL LAYER

(76) Inventor: WARREN BLACKWELL, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/357,135

(22) Filed: Jan. 21, 2009

Related U.S. Application Data
(60) Provisional application No. 61/022,690, filed on Jan. 22, 2008.

(51) Int. Cl. H04B 17/00

(52) U.S. Cl. 375/228

(57) ABSTRACT

Methods and apparatuses for monitoring MIMO channel transactions to determine MIMO channel characteristics.

This U.S. Patent Application claims priority to U.S. Provisional Patent Application No. 61/022,690, filed Jan. 22, 2008.

### TECHNICAL FIELD

Embodiments of the invention relate to wireless communications. More particularly, embodiments of the invention relate to techniques and devices to provide improved multi-antennae communications.

### BACKGROUND

Current wireless local area network (WLAN) installations are typically based on IEEE 802.11b or IEEE 802.11g standards. IEEE 802.11b standards generally provide bandwidth up to 11 megabits per second (Mbps). The subsequent IEEE 802.11g standard provides bandwidth of up to 54 Mbps.

One strategy for providing further increases in bandwidth include IEEE 802.11n, which is currently in draft status. IEEE 802.11n utilizes multiple input/multiple output (MIMO) technology, which includes multiple transmit antennae and multiple receive antennae.

### SUMMARY

A multiple input/multiple output (MIMO) channel between an access point and a remote station is monitored to determine one or more channel characteristics. The monitoring is performed by network management client that is neither the access point nor the remote station. The network management client analyzes the one or more channel characteristics to determine one or more performance parameters corresponding to the MIMO channel. The network management client generates a human-readable result indicating the performance parameters.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a wireless network.

FIG. 2 is a flow diagram of one embodiment of a technique for use of channel sounding information.

FIG. 3 is a block diagram of one embodiment of an electronic device that may operate as a network management client device.

FIG. 4 is a block diagram of one embodiment of a network management agent.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

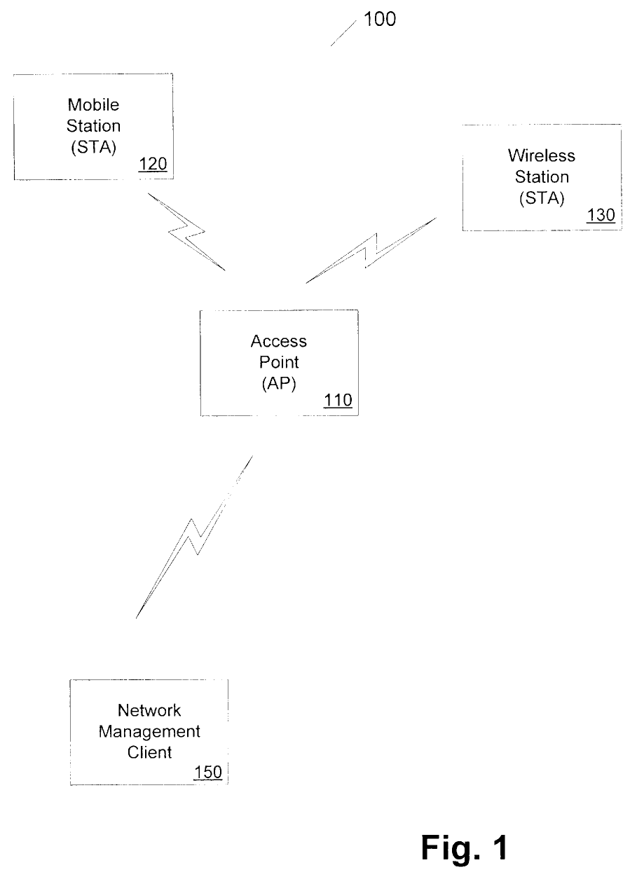

FIG. 1 is a block diagram of one embodiment of a wireless network. FIG. 1 provides an example network with a limited number of network elements for reasons of simplicity only. The techniques and components described herein can be utilized in a network having any number of access points, wireless stations and network management clients. In one embodiment, network 100 operates using at least IEEE 802.11n-compliant wireless communications; however, the strategies described herein may be utilized in wireless networks using other wireless communication protocols.

Access point 110 is any wireless access point (AP) that may provide wireless compunctions with one or more stations (STAs). For example, access point 110 may provide a wired interface to an external network (not illustrated in FIG. 1). Access point 110 may also provide a wireless interface to another network (also not illustrated in FIG. 1). In one embodiment, access point 110 supports the IEEE 802.11n protocol. That is access point 110 may provide communications compliant with at least the IEEE 802.11n protocol. Other protocols, whether wired or wireless, may also be supported by access point 110.

In the example of FIG. 1, mobile station 120 and wireless station 130 may communicate with access point 110 using wireless protocols. In one embodiment, mobile station 120 may be any type of mobile device that can communicate using the wireless protocols supported access point 110. For example, mobile station 120 can be a laptop computer, a smartphone, a tablet device, etc. In one embodiment, wireless station 130 may be any type of device, whether mobile or not, that can communicate using the wireless protocols supported by access point 110. For example, wireless station 130 can be a desktop computer, a real-time sensor, etc.

Network management client 150 may be any type of electronic device that provides network management services to wireless network 100. As described in greater detail below, network management client 150 may monitor communications between access point 110 and either mobile station 120 or wireless station 130 (and other network devices as well) to gather information that may be used in management of wireless network 100. In one embodiment, network 100 may include additional sensors coupled with network management client 150 (not illustrated in FIG. 1) that may allow network management client 150 to monitor a wider geographic area than would otherwise be possible.

In one embodiment, network management client 150 provides radio frequency (RF) site survey services, which may include for example measurement of signal strength, noise, and other related parameters. In a MIMO embodiment, the site survey services may be supplemented by MIMO channel information, by initiating, capturing, storing and interpreting the MIMO channel information exchanged between STAs at the MAC layer. Described herein are various techniques and devices suitable to monitor a MIMO channel between a particular access point (AP location) and one point (e.g., a STA) another along the site survey path.

Descriptions of a MIMO channel are estimated and exchanged between STAs, in a process generally called channel sounding. In the IEEE 802.11n MAC layer, the MIMO Control Field is used to manage the exchange of MIMO Channel state or transmit beamforming feedback information. In addition to the MIMO Control Field, the MIMO CSI Matrices Report Field, the MIMO Non-compressed Beamforming Feedback Matrices Report Field and the MIMO Compressed Beamforming Feedback Matrices Report Field may all be used to describe some aspects of the MIMO channel. In other MIMO protocols, different fields and/or different messaging formats can be used to transmit channel information.

In one embodiment, network management client 150 passively monitors channel sounding and other MIMO channel information exchanges between access point 110 and one or more STAs (e.g., mobile station 120 and/or wireless station 130). The data fields of such exchanges are parsed, interpreted and a determination is made as to how spatially diverse the channel is between the AP and the STAs it is servicing. In this embodiment, a user may be notified that a particular STA is not in a suitable location (relative to the AP) to take advantage of the benefits of MIMO. The notification may be provided via a user interface, a message, or any other suitable human interface.

In another embodiment, a STA device actively associates with access point 110 and initiates channel sounding exchanges with the access point 110, from multiple physical locations (along a particular survey path) to perform a MIMO channel survey. In this embodiment, a user may become aware of locations (relative to access point 110, for example) which are lacking the spatial diversity to take advantage of the benefits of MIMO. This information may be provided to the user via a user interface, a message or any other suitable human interface. For example, an application may generate a color coded (or shaded) map of the network topology with various colors indicating signal strength, diversity, etc.

With the expected growth of IEEE 802.11n and MIMO in the WLAN and wireless space, characterization of the MIMO channel may become an important tool. One may liken this to finding “dead spots” for a SISO (single stream) implementation, due to signal attenuation and multipath effects, except in this case, we are looking for the absence of spatial diversity (multi-path). Multi-path is a required component of the MIMO channel in order for spatial multiplexing to be effective. In the absence of multi-path, a MIMO system degrades to single stream and thus, lowers the overall data rate.

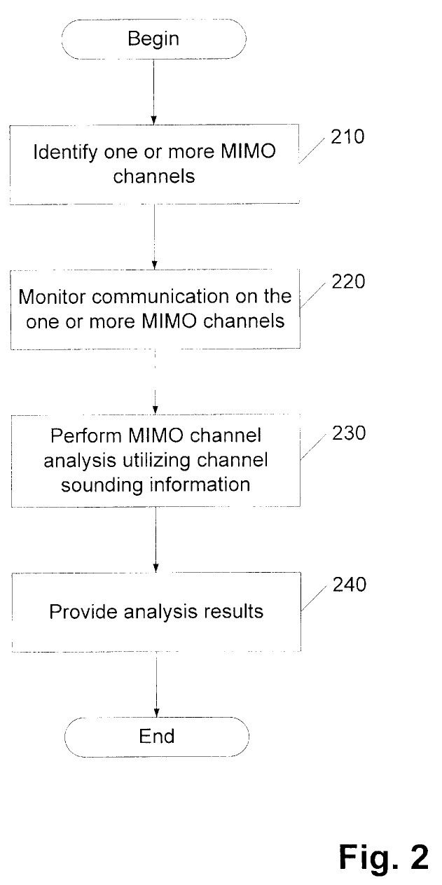

FIG. 2 is a flow diagram of one embodiment of a technique for use of channel sounding information. In one embodiment, the operations of FIG. 2 are performed by a network management client device; however, the operations may be performed by different devices and/or a combination of devices.

One or more MIMO channels are identified, 210. In one embodiment, the network management client can monitor wireless communications within its range to determine the type of transactions occurring between one or more access points and one or more stations. For example, the network management client may search for IEEE 802.11n formatted transactions and determine the source and destination of the transactions. Other wireless transaction information may also be utilized.

Communications over the one or more MIMO channels may then be monitored, 220. The network management client may gather information from multiple transactions to acquire sufficient information to perform channel analysis. In one embodiment, wireless communications are passively monitored by the network management client. That is, the network management client “listens to” or “snoops” communications between the access point(s) and the stations.

In one embodiment, the network management client may gather any channel or environmental information included in the wireless communications. For example, the network management client my search for transmissions including channel sounding information and may parse those transmissions for information related to the MIMO channel. Details regarding the transmission of channel state information and channel sounding information according to the IEEE 802.11n standards are provided herein. In alternate embodiments, other frames, fields, etc. may be used to transmit comparable information.

In another embodiment, the network management client may be actively involved in gathering MIMO channel information. For example, after identifying a MIMO channel, the network management client may cause channel sounding information to be transmitted over the MIMO channel. This may be accomplished by the network management client sending a beamforming request for the channel (either directly to the access point or via the station). Other techniques may also be employed by the network management client to cause channel state or channel sounding information to be transmitted and subsequently utilized by the network management client.

The network management client may then use the gathered information to perform MIMO channel analysis. As mentioned above, the network management client may determine geographical regions of good or bad MIMO coverage, etc. Several types of analysis may be performed to enhance operation of the wireless network. That is, by having the network management client monitor and analyze wireless transactions in which it is not directly involved, the resulting network analysis and performance may be improved.

The results of the analysis are provided, 240. The results may take many forms that are suitable for network management. For example, a color-coded representation of MIMO coverage may be presented to a user of the network management client device. A written description may also be provided. The network management client may assign a score to various connections and/or placements that may be used by a network administrator to improved network operation.

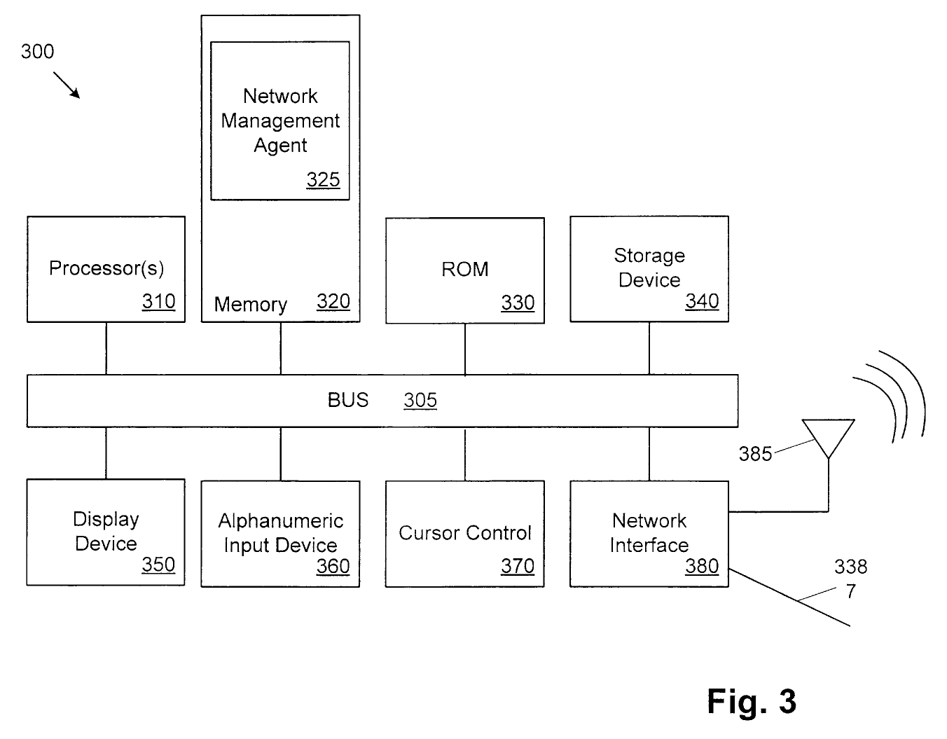

FIG. 3 is a block diagram of one embodiment of an electronic system that may operate as a network management client device. The electronic system illustrated in FIG. 3 is intended to represent a range of electronic systems including, for example, desktop computer systems, laptop computer systems, cellular telephones, personal digital assistants (PDAs) including cellular-enabled PDAs, set top boxes. Alternative electronic systems may include more, fewer and/or different components.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

In one embodiment, network management agent 325 resides in memory 320. Network management agent 325 may provide some or all of the network management functionality described herein. Network management agent 325 may be implemented as software, hardware, firmware or any combination thereof. In some embodiments, instructions that implement network management agent 325 may be executed by processor 310 or some other processing component.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11n and IEEE 802.11b and/or IEEE 802.11g standards, and/or the wireless network interface may provide access to a personal area network, for example, by conforming to Bluetooth standards. Other wireless network interfaces and/or protocols can also be supported.

Instructions are provided to memory from a storage device, such as magnetic disk, a read-only memory (ROM) integrated circuit, CD-ROM, DVD, via a remote connection (e.g., over a network via network interface 330) that is either wired or wireless, etc. In alternative embodiments, hard-wired circuitry can be used in place of or in combination with software instructions. Thus, execution of sequences of instructions is not limited to any specific combination of hardware circuitry and software instructions.

A computer-readable medium includes any mechanism that provides content (e.g., computer executable instructions) in a form readable by an electronic device (e.g., a computer, a personal digital assistant, a cellular telephone). For example, a computer-readable medium may include read only memory (ROM); random access memory (RAM); magnetic disk storage media; optical storage media; flash memory devices; etc.

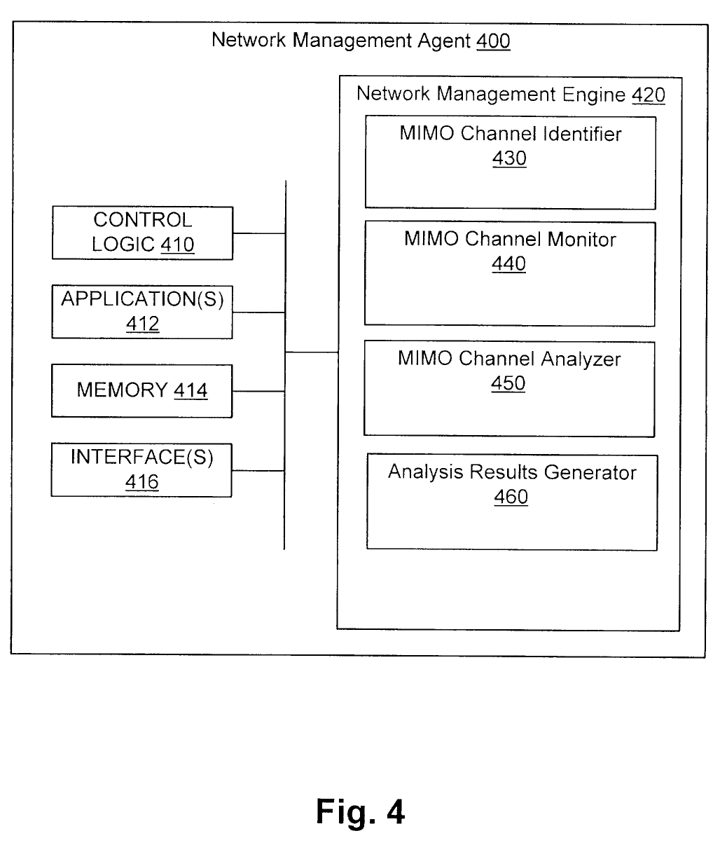

FIG. 4 is a block diagram of one embodiment of a network management agent. Network management agent 400 includes control logic 410, which implements logical functional control to direct operation of network management agent 400, and/or hardware associated with directing operation of network management agent 400. Logic may be hardware logic circuits and/or software routines and/or firmware. In one embodiment, network management agent 400 includes one or more applications 412, which represent code sequence and/or programs that provide instructions to control logic 410.

Network management agent 400 includes memory 414, which represents a memory device and/or access to a memory resource for storing data and/or instructions. Memory 414 may include memory local to network management agent 400, as well as, or alternatively, including memory of the host system on which network management agent 400 resides. Network management agent 400 also includes one or more interfaces 416, which represent access interfaces to/from (an input/output interface) network management agent 400 with regard to entities (electronic or human) external to network management agent 400.

Network management agent 400 also network management engine 420, which represents one or more functions that enable network management agent 400 to provide the real-time, or near real-time, streaming as described above. The example of FIG. 4 provides several components that may be included in network management engine 420; however, different and/or additional components may also be included. Example components that may be involved in providing the streaming environment include MIMO channel identifier 430, MIMO channel monitor 440, MIMO channel analyzer 450 and analysis results generator 460. Each of these components may further include other components to provide other functions. As used herein, a component refers to routine, a subsystem, etc., whether implemented in hardware, software, firmware or some combination thereof.

MIMO channel identifier 430 identifies one or more MIMO channels in use within range of the network management client device. For example, MIMO channel identifier 430 may analyze signals detected by one or more antennae to determine whether any of the received signals correspond to a supported MIMO protocol (e.g., IEEE 802.11n). MIMO channel identifier 430 may also perform additional functions related to detection and/or identification of MIMO channels.

MIMO channel monitor 440 may provide monitoring functionality for the MIMO channels identified by MIMO channel identifier 430. MIMO channel monitor 440 may, for example, parse frames (or other structures) transmitted over MIMO channels identified by MIMO channel identifier 430. MIMO channel identifier 430 may extract information, for example, values from selected frames or fields, that may be used to analyze the corresponding MIMO channel. MIMO channel monitor 440 may also perform additional functions related to monitoring of the MIMO channels.

MIMO channel analyzer 450 may provide analyze the data parsed and stored by MIMO channel monitor 440. For example, MIMO channel analyzer 450 may use values from the extracted fields to determine a score for the corresponding MIMO channel that may indicate the signal quality and/or performance of the channel. Other types of analysis described herein may also be performed by MIMO channel analyzer 450. MIMO channel analyzer 450 may also perform additional functions related to analysis of MIMO channels.

Analysis results generator 460 may provide results from MIMO channel analyzer in a human-usable format. For example, analysis results generator 460 may generate a color-coded graphical representation of the monitored network where various colors indicate channel quality, bandwidth, and/or other characteristics. A representation of the monitored network may include suggested locations for one or more network stations that correspond to estimates of optimal placement in terms of MIMO channel performance when communicating with a particular access point. Analysis results generator 460 may also provide a numerical indication of various network characteristics. As another example, analysis results generator 460 may generate a message (e-mail, text, etc.) to a network administrator if certain characteristics are considered too high or too low. Analysis results generator 460 may also perform additional functions related to analysis of MIMO channels.

The appendix attached hereto provides specific frames, fields and values for an embodiment utilizing IEEE 802.11n communications. Alternate embodiments may utilize different frames, fields and values.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
monitoring a multiple input/multiple output (MIMO) channel between an access point and a remote station to determine one or more channel characteristics, wherein the monitoring is performed by network management client that is neither the access point nor the remote station;
analyzing the one or more channel characteristics to determine one or more performance parameters corresponding to the MIMO channel; and
generating a human-readable result indicating the performance parameters.

2. The method of claim 1 wherein wireless communications over the MIMO channel conform to an IEEE 802.11n standard.

3. The method of claim 1 wherein the one or more channel characteristics comprises channel sounding information.

4. The method of claim 1 wherein the human-readable result comprises a graphical representation of a monitored network where colors indicate different levels of MIMO channel performance.

5. The method of claim 1 further comprising:
causing a channel sounding transaction between the access point and the remote station with the network management agent;
monitoring subsequent transactions between the access point and the remote station with the network management unit for channel sounding information resulting from the channel sounding transaction; and
performing MIMO channel performance analysis for the MIMO channel utilizing the channel sounding information.

6. An article comprising a computer-readable medium having stored thereon instructions that, when executed by one or more processors, cause the one or more processors to:
monitor a multiple input/multiple output (MIMO) channel between an access point and a remote station to determine one or more channel characteristics, wherein the monitoring is performed by network management client that is neither the access point nor the remote station;
analyze the one or more channel characteristics to determine one or more performance parameters corresponding to the MIMO channel; and
generate a human-readable result indicating the performance parameters.

7. The article of claim 6 wherein wireless communications over the MIMO channel conform to an IEEE 802.11n standard.

8. The article of claim 6 wherein the one or more channel characteristics comprises channel sounding information.

9. The article of claim 6 wherein the human-readable result comprises a graphical representation of a monitored network where colors indicate different levels of MIMO channel performance.

10. The article of claim 6 further comprising instructions that, when executed by the one or more processors, cause the more or ore processors to:
cause a channel sounding transaction between the access point and the remote station with the network management agent;
monitor subsequent transactions between the access point and the remote station with the network management unit for channel sounding information resulting from the channel sounding transaction; and
perform MIMO channel performance analysis for the MIMO channel utilizing the channel sounding information.

11. An apparatus comprising:
means for monitoring a multiple input/multiple output (MIMO) channel between an access point and a remote station to determine one or more channel characteristics, wherein the monitoring is performed by network management client that is neither the access point nor the remote station;
means for analyzing the one or more channel characteristics to determine one or more performance parameters corresponding to the MIMO channel; and
means for generating a human-readable result indicating the performance parameters.

12. The apparatus of claim 11 further comprising:
means for causing a channel sounding transaction between the access point and the remote station with the network management agent;
means for monitoring subsequent transactions between the access point and the remote station with the network management unit for channel sounding information resulting from the channel sounding transaction; and
means for performing MIMO channel performance analysis for the MIMO channel utilizing the channel sounding information.
